(19) United States
(12) Patent Application Publication
(10) Pub. No.: US 2004/0244040 A1
(43) Pub. Date: Dec. 2, 2004

(54) Remote cable system

(76) Inventors: Walter Andrew Vickers, Newnan, GA (US); Mitchell C. Jaffe, Atlanta, GA (US)

Correspondence Address: TECHNOPROP COLTON, L.L.C., P O BOX 567685, ATLANTA, GA, 311567685

(21) Appl. No.: 10/452,655

(22) Filed: Jun. 2, 2003

(51) Int. Cl. H04N 7/173; H04N 5/50; H04N 7/16; H04N 7/18

(52) U.S. Cl. 725/81; 725/80; 725/74; 725/131; 725/139; 348/731; 348/734; 725/120

(57) ABSTRACT

A remote cable system for wirelessly transmitting an input wired signal to a remote playback device having a transmitting component for receiving the input wired signal and transmitting the input wired signal as a wireless RF signal and a receiving component for receiving the wireless RF signal and transmitting the wireless RF signal as an output wired signal to the remote playback device.

### BACKGROUND OF THE INVENTION

1. Technical Field

The present invention generally relates to a system for receiving and wirelessly retransmitting an audio/video signal, and more particularly relates to a system for receiving an audio/video signal from a common coaxial cable and wirelessly transmitting the signal as a radio frequency (RF) to a remote location.

2. Prior Art

Currently, consumer audio/video signals are transmitted via a source antenna and are received and utilized via a receiving device, or are transmitted via a cable from a source to a receiving device. Common examples of audio/video signals transmitted from a source antenna are broadcast airwave radio and television (TV) signals broadcast from an antenna at the source of the radio or TV broadcast, such as a radio or TV production facility or a related antenna farm. Such broadcast airwave signals are received by a common radio or TV and converted to audio/video. These types of broadcast airwave signals are subject to atmospheric and other interferences, and decrease in quality and strength over distance.

Common examples of audio/video signals transmitted via a cable are cable television (CATV) signals broadcast over a cable from the source of the CATV broadcast, such as a TV production facility. Another common example of a cable signal is a home entertainment center where an audio/video signal is generated by a electronic component, such as a compact disc (CD), digital video disc (DVD), video cassette players, audio cassette players, eight-track tape players, or phonograph, and is sent to a video monitor and/or audio speakers via speaker wires, often through a central console.

Recently, many TV and radio stations have started “webcasting”—directly transmitting the audio/video via the Internet. Internet signals generally are delivered to a home or other location via a cable, such as a so-called T1 line, or a telephone line, such as a dial-up line or a digital subscriber line (DSL). Such webcasting signals are becoming common and are included as consumer audio/video signals.

A common feature of cable signals is that they are delivered to a location via a single input. For example, CATV is delivered to a home via a single coaxial cable from the street to the home. DSL is delivered to a home via a single telephone line from the street to the home. DVD signals are delivered to the television and speakers generally via a single cable from the DVD player to the console.

There have been various inventions for redirecting, splitting, retransmitting and/or distributing signals within a home or other structure. However, these inventions generally are complex systems, wired systems, or satellite systems. Some examples of the prior art follow.

U.S. Pat. No. 4,142,156 to Freund discloses a cable or CATV system consisting of a central station with a television transmitter connected via television transmission cables to a plurality of remote stations with a television receiver. U.S. Pat. No. 5,418,577 to Bagley discloses a remote audio monitoring system comprising an FM transmitter and at least one FM receiving terminal in which the transmitter is coupled to an audio channel of a cable or satellite descrambler box and transmits the signal from the descrambler box to the receiver for broadcast. U. S. Pat. No. 5,579,308 to Humpleman discloses a home network architecture having an internal digital network for interconnecting devices in a home in which the network architecture is connected by a direct circuit crossbar.

U.S. Pat. No. 5,708,961 to Hylton et al. discloses a digital network that delivers multiplexed channels to a customer's premise using a distribution system for wireless service from the service provider directly to units located on a customer's premise, which essentially removes the need for wiring between the service provider and the consumer's premise. U.S. Pat. No. 5,835,128 to Macdonald et al. discloses a system for redistributing a television signal to a multiplicity of receiver units within a multiple dwelling unit in which the receivers are positioned at local sites on the dwelling and from the local site the signal is propagated along the walls to the various individual dwelling units.

U.S. Pat. No. 6,069,621 to Schupak discloses a distributed computer system for receiving any one audio signal, video signal or any information at a central location and for supplying any one of the signals to a remote location, which appears to be controlled by a computer. U.S. Pat. No. 6,263,503 to Margulis discloses a method for implementing a wireless television system comprising a wireless base station that processes and combines various program sources to produce a processed stream and a transmitter that responsively transmits the processed stream to various devices, including a television, at remote locations.

U.S. Pat. No. 6,481,013 to Dinwiddie et al. discloses an apparatus for distributing RF modulated broadcast television signals from a broadcast signal source to networked appliances connected to the source through a plurality of single conductor coaxial cable that makes use of the coaxial cables to distribute the broadcast signals. U.S. Pat. No. 6,493,875 to Eames et al. discloses an apparatus for the distribution of video data and telephony signals within a residence by transferring a signal, containing compressed digital video information, to a wireless module for transmission to a remote receiver using spread spectrum communications. Further, the Eames '875 patent discloses the application of codes to the spectrum to reduce interference and distinguish between different residences and appears to work through extracting (and decoding) MPEG video packets and to be directed towards bidirectional telecommunications.

Thus, there is a need for a simple system for receiving cable signals and distributing the cable signals wirelessly through a building to a single or multiple locations within the building. There also is a need for such a system to be effective enough to eliminate the need to run cable throughout the building. There also is a need for a system that can be placed proximal to the cable signal input and the remote TV system yet remain unobtrusive. Finally, there is a need for a device that addresses the above issues, and others, that is simple and automatic to operate without much if any user intervention. It is to these needs that the present invention is directed.

### BRIEF SUMMARY OF THE INVENTION

Briefly, the invention generally is a system for allowing a user to have a single cable signal input in one location of a building, sending the cable signal wirelessly throughout the building, and receiving and playing the signal on remote devices. The invention more specifically comprises a common cable signal input connection component, a transmitting component for transmitting the cable signal wirelessly throughout the building, and one or more receiving components for receiving the wireless cable signal and delivering the cable signal to remote playback devices in one or more different locations in the building.

Using the CATV field as an example, one embodiment of the invention generally is a system for allowing a user to have a TV in a location remote from the CATV input plug and still receive a signal from the CATV plug. Often, a room, a house, or a building only has one cable signal input plug. The placement of the single cable signal input plug within the building often is at the discretion of the CATV provider and often is not convenient to the user. For example, the cable signal input plug may be on one side of a room whereas the user would like to place the TV on a different side of the room or in a different room altogether. Thus, to access the cable signal, the user would have to run cable from the cable input plug around the room or through the walls to the other side of the room or to the other room. The present invention alleviates this inconvenience.

A transmitting component is connected to the cable signal input plug. The transmitting component plugs into the CATV plug and transmits the CATV signal as a radio frequency (RF) signal wirelessly throughout the building. A receiving component, which plugs into a remote TV, receives the RF signal and inputs the cable signal into the remote TV. Thus, the TV can be placed remote from the cable signal input plug. Further, several different remote TVs can be coupled with receiving components allowing the user to have several different remote TVs throughout the building receive the cable signal.

Another embodiment of the invention includes using the signal from a home entertainment center as the input signal. In this embodiment the signal from the entertainment console, be it a DVD or any other audio/video media, is inputted to the transmitting component. Yet another embodiment of the invention includes using a single signal from a CATV or other provider and transmitting the signal to various receiving components located throughout a multi-family or multi-business building. In this embodiment, the building manager or owner can eliminate the presence of multiple cables on the outside of the building and the need for laying multiple cables within the building. Still another embodiment of the invention includes the use of security technology such as SIMS cards to prevent unauthorized persons from receiving and using the transmitted cable signal.

The invention can be housed in a variety of physical structures. For example, the transmitting component of the invention can be housed in a standalone box, in the cable channel selection box, or as part of a TV or other audio/video component. Likewise, the receiving component of the invention also can be housed in a standalone box, in the cable channel selection box, or as part of a TV or other audio/video component. It is contemplated that TV manufacturers will choose to include the invention in consumer TVs such that the various TVs within a dwelling or a building will be able to transmit cable signals and other RF signals wirelessly to each other in a plug and play manner.

These features and other features and advantages of the present invention will become more apparent to those of ordinary skill in the relevant art when the following detailed description of the preferred embodiments is read in conjunction with the appended drawings in which like reference numerals designate like components throughout the several views.

### BRIEF DESCRIPTION OF THE DRAWINGS

FIG. 1 is a schematic of the system of the present invention.

FIG. 2 is a schematic of an embodiment of the transmitting and receiving components of the present invention.

FIG. 3 is a schematic of an embodiment of the present invention using multiple receiving televisions.

FIG. 4 is a schematic of an embodiment of the present invention used in a multifamily building.

FIG. 5 is a schematic of an embodiment of the transmitting component of the present invention using security technology.

### DETAILED DESCRIPTION OF THE PREFERRED EMBODIMENTS

The present invention is a system for allowing a user to have a single cable signal input in one location of a building, to send the cable signal wirelessly throughout the building, and to receive and play the signal on remote devices.

The invention comprises a common cable signal input connection component, a transmitting component for transmitting the cable signal wirelessly throughout the building, and one or more receiving components for receiving the wireless cable signal and delivering the cable signal to remote playback devices in different locations in the building.

Using the CATV field as the representative embodiment, the invention is a system for allowing a user to have a TV in a location remote from the CATV input plug and still receive a signal from the CATV plug. Often, a room, a house, or a building only has one cable signal input plug placed at the discretion of the CATV provider. Often this placement is not convenient to the user and, for example, the cable signal input plug may be on one side of a room whereas the user would like to place the TV on a different side of the room or in a different room altogether. To access the cable signal, the user would have to run cable from the cable input plug around the room or through the walls to the other side of the room or to the other room.

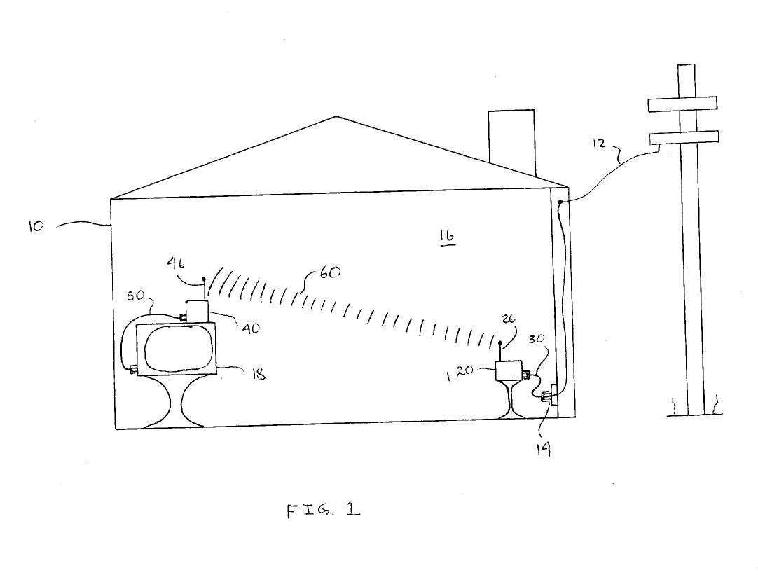

Referring now to FIG. 1, a generalized schematic representation of the system of the present invention is shown. The system minimally comprises a transmitting component 20 and a receiving component 40. A house 10 or other structure comprises a cable connection consisting of a cable 12 strung from the street to the house 10. The cable 12 terminates in a cable connection 14 located somewhere within a room 16 of the house 10. For the sake of the present disclosure, the owner of the house 10 would like to place her TV 18 in a location remote from the cable connection 14, which in the present example is across the room 16.

Although the embodiment shown in FIG. 1 illustrates the use of traditional cable strung from the street to the building, the invention is not limited to this. A computer running a DVD or an audio/video application from a hard drive or a CD, a satellite dish, or any other audio/video signal source is suitable for the signal input to the invention.

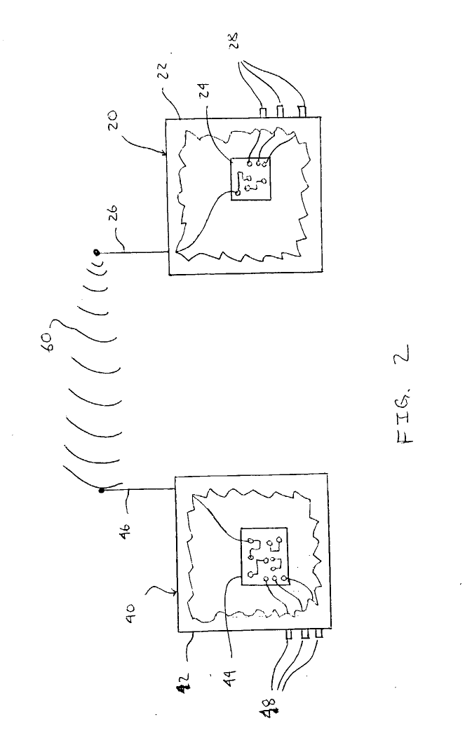

A transmitting component 20 is connected to the cable signal input plug, such as the cable connection 14. The transmitting component 20 plugs into the cable connection 14 and transmits the CATV signal as a radio frequency (RF) signal 60 wirelessly throughout the house 10. As shown in more detail in FIG. 2, transmitting component 20 preferably is a relatively small and discrete structure comprising a housing 22 containing the transmitting electronics 24 necessary to wirelessly transmit an inputted cable signal, a transmitting antenna 26 for actually transmitting the RF signal 60, and terminals 28 for connecting the transmitting component 20 to the cable signal source. In the example shown in FIG. 1, the cable signal source is a CATV provider at the other end of the cable 12. As disclosed below, the cable signal source can be a myriad of other sources, such as a home entertainment center and the Internet.

Transmitting component 20 can be attached directly to cable connection 14 and is shown in the illustrative embodiment of FIG. 1 attached to the cable connection 14 via a first connecting cable 30. First connecting cable 30 comprises a connector that mates with the cable connection 14. For example, most common CATV cable is coaxial and has a standard terminus design. First connecting cable 30 thus would comprise a standard connector that cooperates with the terminus attached to the cable 12. First connecting cable 30 can be securely attached to the transmitting electronics 24 or can be releasably attached to terminals 28.

A receiving component 40, which plugs into a remote TV 18, receives the wireless RF signal 60 and inputs the cable signal into the remote TV 18. As shown in more detail in FIG. 2, receiving component 40 also preferably is a relatively small and discrete structure comprising a housing 42 containing the receiving electronics 44 necessary to wirelessly receive the RF signal 60, a receiving antenna 46 for actually receiving the RF signal 60, and terminals 48 for connecting the receiving component 40 to the remote TV 18. As disclosed below, the remote TV can be replaced with other display devices or playing devices.

Receiving component 40 can be attached directly to the remote TV 18 and is shown in the illustrative embodiment of FIG. 1 attached to the remote TV 18 via a second connecting cable 50. Second connecting cable 50 comprises a connector that mates with the remote TV 18. Similar to the disclosure above, most common TVs use is coaxial cable with standard terminus designs. Second connecting cable 50 thus would comprise a standard connector that cooperates with the terminus attached to the remote TV 18. Second connecting cable 50 can be securely attached to the receiving electronics 44 or can be releasably attached to terminals 48.

Thus, the CATV signal sent by the CATV signal provider enters house 10 via cable 12, which terminates generally at a cable connection 14 plug on a wall in a room 16 of the house 10. A first connecting cable 30, typically of a common coaxial design, connects the transmitting electronics 24 within the transmitting component 20 to the cable connection 14, allowing the cable signal to be supplied to the transmitting component 20. Transmitting electronics 24 take the cable signal and deliver the cable signal to the transmitting antenna 26, which transmits the cable signal as a wireless RF signal 60 throughout the house 10.

Both the transmitting component 20 and the receiving component 40 can be integral parts of an audio/video device such as a TV. In an alternate embodiment of the invention, the transmitting component 20 can be a standalone unit connected directly to the cable 12, while the receiving component 40 can be an integral part of the remote TV 18. In this alternate embodiment, the invention is somewhat simplified, as the remote TV 18 is a unitary structure, with the receiving component 40 wired directly to the TV circuitry. In still another alternate embodiment, both the transmitting component 20 and the receiving component 40 can be an integral part of each TV in the building. In this alternate embodiment, the cable 12 input can be connected directly to a first TV, which can transmit the cable signal wirelessly throughout the building as wireless RF signal 60, to be received by one or more remote TVs 18. Each TV thus can be set to a transmitting mode, a receiving mode, or both modes.

In the integral example embodiments given immediately above, the invention can be, in effect, a typical commercially available TV further comprising either the transmitting component 20 and or the receiving component 40. By commercially available TV, what is meant is the common TV device comprising a monitor or cathode ray tube, a tuner, and a signal input means, such as an antenna or a cable connection. Commercially available TVs also can include CATV and or satellite receiving and decoding circuitry, as well as other known signal input means. To this commercially available TV, additional circuitry for implementing the invention can be added, along with the additional receiving antenna 46 for receiving the wireless RF signal 60 and/or the additional transmitting antenna 26 for transmitting the wireless RF signal. Alternatively, the receiving antenna that is part of the commercially available TV also may be used as the receiving antenna 46 and the transmitting antenna 26.

The receiving antenna 46 receives the wireless RF signal 60 and delivers the wireless RF signal 60 as the cable signal to the receiving electronics 44. A second connecting cable 50, also typically of a common coaxial design, connects the receiving electronics 44 within the receiving component 40 to the remote TV 18, allowing the cable signal to be supplied to the remote TV. Thus, the remote TV 18 can be placed remote from the cable connection 14. Further, several different remote TVs 18 can be coupled with several different receiving components 40 allowing the user to have several different remote TVs 18 throughout the house 10 receive the cable signal.

Referring now to FIG. 2, the transmitting component 20 and the receiving component 40 are show in more detail. Both transmitting component 20 and receiving component 40 are relatively simple devices. Each respectively comprises a housing 22, 42, transmitting or receiving electronics 24, 44, an antenna 26, 46, and terminals 28, 48. Each also comprises an appropriate power supply (not shown), such as batteries or a solar cell array, or the appropriate components to connect to a power supply, such as an external alternating current (AC) or direct current (DC) source, as well as the appropriate wiring between components so that the components are in electrical connectivity with each other. Housing 22, 42, antenna 26, 46, terminals 28, 48, power sources, and wiring can be interchangeable between transmitting component and receiving component 40. All of the components for transmitting component 20 and receiving component 40 are known in the art and readily assembled by those of ordinary skill in the art.

Transmitting electronics 24 can be any known RF transmitter capable of receiving a wired input and delivering this input to a transmitting antenna 26. In the illustrative embodiment shown in FIG. 2, the input is the cable signal from CATV cable 12. An appropriate terminal 28 and first connecting cable 30 connects cable 12 to transmitting electronics 24, allowing the cable signal to be delivered.from cable 12 to transmitting electronics, which in turn delivers the cable signal to transmitting antenna 26, which in turn transmits the cable signal as a wireless RF signal 60.

Receiving antenna 46 receives wireless RF signal 60 and delivers wireless RF signal 60 to receiving electronics 44. Receiving electronics 44 can be any known RF receiver capable of receiving a wireless input and delivering this input as a wired signal to a playback device, such as remote TV 18. An appropriate terminal 48 and second connecting cable 50 connects receiving electronics 44 to remote TV 18, allowing the received cable signal to be delivered from receiving electronics 44 to remote TV 18.

Another embodiment of the invention includes using the signal from a home entertainment center as the input signal. In this embodiment the signal from the entertainment console, be it a DVD or any other audio/video media, is inputted to the transmitting component. The receiving component can be connected to a remote TV, if a video signal is being transmitted, and to loudspeakers, if an audio signal also is being transmitted. As should now be obvious to those of ordinary skill in the art, the input signal to the transmitting component is virtually unlimited and all that is necessary is to attach the appropriate playback device to the receiving component 40 to match or take advantage of the particular type or types of input signal or signals.

Further, each of transmitting component 20 and receiving component 40 can have multiple terminals 28. For example, transmitting component 20 can have multiple terminals 28 allowing input signals from multiple input signal generating devices or from different types of input signal generating devices. Likewise, receiving component 40 can have multiple terminals 28 allowing output signals to multiple output signal playback devices or to different types of output signal playback devices. Similarly, transmitting electronics 24 can be of the type allowing the transmission of multiple signals simultaneously, and receiving electronics 44 can be of the type allowing the reception of multiple signals simultaneously.

Yet another embodiment of the invention includes using a single signal from a CATV or other input signal provider and transmitting the signal to various receiving components either located within a single family or business building or located throughout a multi-family or multi-business building. In these embodiments, the presence of multiple cables on the outside of the building and the need for laying multiple cables within the building can be eliminated.

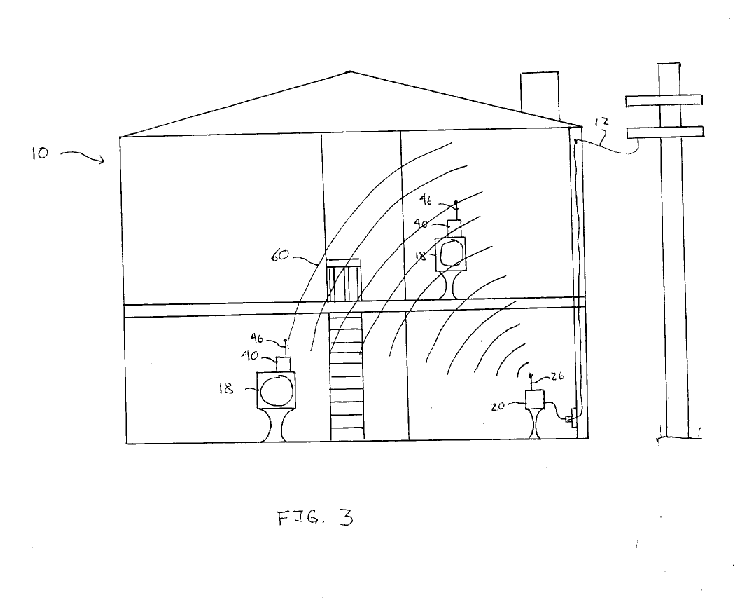

Referring now to FIG. 3, a single transmitting component 20, multiple receiving component 40 embodiment of the invention for use in a single family or single business building 10 is shown. In this embodiment, the input signal is supplied from the cable 12 to the transmitting component 20. The transmitting component 20 transmits the input signal as a wireless RF signal 60 throughout the building. Multiple remote TVs 18 are each connected to a receiving component 40, which receives the wireless RF signal 60. In this manner, multiple remote TVs 18 can receive the wireless RF signal 60 and playback the input cable signal. As transmitting component 20 preferably is capable of transmitting the entire input signal as the wireless RF signal 60 at once, and receiving components 40 are capable or receiving the entire input signal as the wireless RF signal 60 at once, remote TVs 18 each can be tuned to a different frequency, thus allowing the user of one remote TV 18 to view a different station as the user of another remote TV 18.

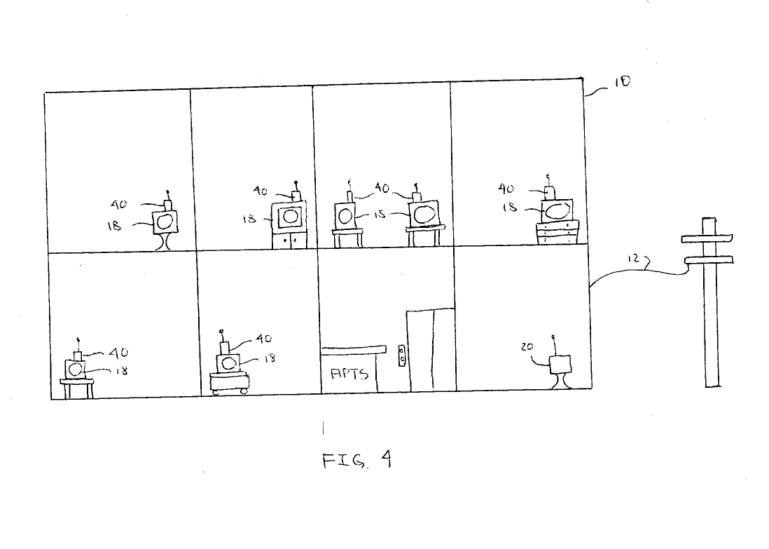

Referring now to FIG. 4, a single transmitting component 20, multiple receiving component 40 embodiment of the invention for use in a multi-family or multi-business building is shown. In this embodiment, the input signal is supplied from the cable 12 to the transmitting component 20, typically centrally located in a building manager's office or in an electronics room or on the outside of the building. The transmitting component 20 transmits the input signal as a wireless RF signal 60 throughout the building. Multiple remote TVs 18 in separate family units or office suites are each connected to a receiving component 40, which receives the wireless RF signal 60. In this manner, multiple remote TVs 18 can receive the wireless RF signal 60 and playback the input cable signal. As transmitting component 20 preferably is capable of transmitting the entire input signal as the wireless RF signal 60 at once, and receiving components 40 are capable or receiving the entire input signal as the wireless RF signal 60 at once, remote TVs 18 each can be tuned to a different frequency, thus allowing the user of one remote TV 18 to view a different station as the user of another remote TV 18.

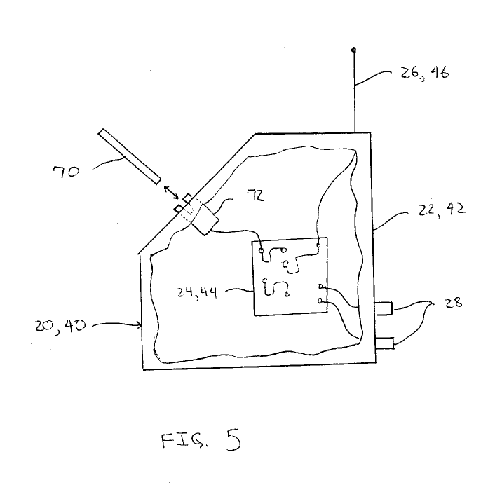

Referring now to FIG. 5, still another embodiment of the invention includes the use of security technology such as SIMS cards 70 and SIMS card readers 72 to prevent unauthorized persons from receiving and using the transmitted cable signal. Representative SIMS card or other security card or signal technology is known in the art, and any appropriate security technology can be used in the present invention. Such security technology could allow signal input providers to limit the number of remote devices 18 in use, and to prevent unauthorized reception of wireless RF signals 60. Additionally, such security technology could allow the managers of multi-family and multi-business buildings to allow the reception of the wireless RF signal 60 only by those families or businesses paying for or otherwise authorized to receive the input signal.

A first example security technology can incorporate electronic serial numbers in the transmitting component 20 and the receiving component 40 and could allow reception of the wireless RF signal only by receiving components 40 having matching or authorized electronic serial numbers relative to the transmitting component 20. Such technology could be hard-wired into the transmitting component 20 and the receiving component 40 or embedded onto removable SIMS or TYPE-type cards 70 that are inserted into SIMS card readers 72 located on either or both of transmitting component 20 and receiving component 40.

A second example security technology can incorporate electronic passkeys in the form of, for illustrative purposes only, SIMS cards 70. A first SIMS card with an appropriate electronic key can be inserted into a SIMS card reader 72 in the transmitting component 20, thus activating the transmitting component 20 and allowing it to transmit the wireless RF signal 60. A second SIMS card with an appropriate matching or cooperating electronic key can be inserted into a second SIMS card reader 72 in the receiving component 40, thus activating the receiving component 40 and allowing it to receive the wireless RF signal 60 transmitted by the appropriate transmitting component 20.

An alternative embodiment of the invention includes the use of infrared (IR) and other light-based transmitters and receivers. However, this would involve a line-of-sight requirement between transmitting component 20 and receiving component 40. Another alternative embodiment of the invention includes the use of repeaters (not shown) throughout the building 10 so as to allow the use of very low power wireless RF signals 60. This would help prevent the wireless RF signal 60 from leaking out of the building 10 and causing interference with other RF devices or prevent theft of the RF signal 60 by unauthorized persons.

The above detailed description of the preferred embodiments, examples, and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A remote cable system for wirelessly transmitting an input wired signal to a remote playback device comprising:
a. a transmitting component for receiving the input wired signal and transmitting the input wired signal as a wireless RF signal; and
b. a receiving component for receiving the wireless RF signal and transmitting the wireless RF signal as an output wired signal to the remote playback device.

2. The remote cable system as claimed in claim 1, wherein the transmitting component comprises a radio frequency transmitter circuit and a transmitting antenna.

3. The remote cable system as claimed in claim 1, wherein the receiving component comprises a radio frequency receiver circuit and a receiving antenna.

4. The remote cable system as claimed in claim 2, wherein the transmitting component further comprises a housing for containing the radio frequency transmitter circuit and at least one input terminal for allowing input to the radio frequency transmitter circuit.

5. The remote cable system as claimed in claim 3, wherein the receiving component further comprises a housing for containing the radio frequency receiver circuit and at least one output terminal for allowing output from the radio frequency receiver circuit.

6. The remote cable system as claimed in claim 1, wherein the output wired signal is identical to the input wired signal.

7. The remote cable system as claimed in claim 4, wherein the transmitting component further comprises at least two input terminals for allowing input to the radio frequency transmitter circuit.

8. The remote cable system as claimed in claim 5, wherein the receiving component further comprises at least two output terminals for allowing output from the radio frequency receiver circuit.

9. The remote cable system as claimed in claim 7, wherein the at least two input terminals allow input to the radio frequency transmitter circuit from at least two different input sources.

10. The remote cable system as claimed in claim 8, wherein the at least two output terminals allow output from the radio frequency receiver circuit to at least two different remote playback devices.

11. The remote cable system as claimed in claim 1, further comprising security means for allowing the receiving component to receive the wireless RF signal transmitted by the transmitting component.

12. The remote cable system as claimed in claim 11, wherein the security means comprises the use of electronic serial numbers.

13. The remote cable system as claimed in claim 11, wherein the security means comprises the use of electronic key cards.

14. The remote cable system as claimed in claim 1, further comprising at least two receiving components for receiving the wireless RF signal.

15. The remote cable system as claimed in claim 1, wherein the input wired signal is a multi-channel cable television signal and the remote playback device is a television.

16. The remote cable system as claimed in claim 2, wherein the transmitting component is contained within and is part of a television monitor.

17. The remote cable system as claimed in claim 3, wherein the receiving component is contained within and is part of a television monitor.

18. A remote cable system for wirelessly transmitting an input wired signal to a remote playback device comprising:
a. a transmitting component for receiving the input wired signal and transmitting the input wired signal as a wireless RF signal, wherein the transmitting component comprises a radio frequency transmitter circuit and a transmitting antenna; and
b. a receiving component for receiving the wireless RF signal and transmitting the wireless RF signal as an output wired signal to the remote playback device, wherein the receiving component comprises a radio frequency receiver circuit and a receiving antenna.

19. The remote cable system as claimed in claim 18 wherein the transmitting component further comprises a housing for containing the radio frequency transmitter circuit and at least one input terminal for allowing input to the radio frequency transmitter circuit and the receiving component further comprises a housing for containing the radio frequency receiver circuit and at least one output terminal for allowing output from the radio frequency receiver circuit.

20. The remote cable system as claimed in claim 18 wherein the output wired signal is identical to the input wired signal.

21. The remote cable system as claimed in claim 19, wherein the transmitting component further comprises at least two input terminals for allowing input to the radio frequency transmitter circuit and the receiving component further comprises at least two output terminals for allowing output from the radio frequency receiver circuit.

22. The remote cable system as claimed in claim 21, wherein the at least two input terminals allow input to the radio frequency transmitter circuit from at least two different input sources.

23. The remote cable system as claimed in claim 21, wherein the at least two output terminals allow output from the radio frequency receiver circuit to at least two different remote playback devices.

24. The remote cable system as claimed in claim 18, further comprising security means for allowing the receiving component to receive the wireless RF signal transmitted by the transmitting component.

25. The remote cable system as claimed in claim 24, wherein the security means comprises the use of electronic serial numbers.

26. The remote cable system as claimed in claim 24, wherein the security means comprises the use of electronic key cards.

27. The remote cable system as claimed in claim 18, further comprising at least two receiving components for receiving the wireless RF signal.

29. The remote cable system as claimed in claim 18, wherein the input wired signal is a multi-channel cable television signal and the remote playback device is a television.

30. The remote cable system as claimed in claim 18, wherein the transmitting component is contained within and is part of a television monitor.

31. The remote cable system as claimed in claim 18, wherein the receiving component is contained within and is part of a television monitor.

32. A remote cable system for wirelessly transmitting an input wired signal to a remote playback device comprising:
a. a transmitting component for receiving the input wired signal and transmitting the input wired signal as a wireless RF signal, wherein the transmitting component comprises a radio frequency transmitter circuit, a transmitting antenna, a housing for containing the radio frequency transmitter circuit and at least one input terminal for allowing input to the radio frequency transmitter circuit; and
b. a receiving component for receiving the wireless RF signal and transmitting the wireless RF signal as an output wired signal to the remote playback device, wherein the receiving component comprises a radio frequency receiver circuit, a receiving antenna, and at least one output terminal for allowing output from the radio frequency receiver circuit,
wherein the output wired signal is identical to the input wired signal.

33. The remote cable system as claimed in claim 32, wherein the transmitting component further comprises at least two input terminals for allowing input to the radio frequency transmitter circuit and the receiving component further comprises at least two output terminals for allowing output from the radio frequency receiver circuit.

34. The remote cable system as claimed in claim 33, wherein the at least two input terminals allow input to the radio frequency transmitter circuit from at least two different input sources.

35. The remote cable system as claimed in claim 33, wherein the at least two output terminals allow output from the radio frequency receiver circuit to at least two different remote playback devices.

36. The remote cable system as claimed in claim 33, wherein the at least two input terminals allow input to the radio frequency transmitter circuit from at least two different input sources and the at least two output terminals allow output from the radio frequency receiver circuit to at least two different remote playback devices.

37. The remote cable system as claimed in claim 32, further comprising security means for allowing the receiving component to receive the wireless RF signal transmitted by the transmitting component.

38. The remote cable system as claimed in claim 37, wherein the security means comprises the use of electronic serial numbers.

39. The remote cable system as claimed in claim 37, wherein the security means comprises the use of electronic key cards.

40. The remote cable system as claimed in claim 32, further comprising at least two receiving components for receiving the wireless RF signal.

41. The remote cable system as claimed in claim 32, wherein the input wired signal is a multi-channel cable television signal and the remote playback device is a television.

42. A remote cable system comprising:
a. a transmitting component for receiving an input wired signal and transmitting the input wired signal as a wireless RF signal, wherein the transmitting component comprises a radio frequency transmitter circuit, a transmitting antenna, and at least one input terminal for allowing input to the radio frequency transmitter circuit; and
b. a television comprising a television monitor and a receiving component for receiving the wireless RF signal and transmitting the wireless RF signal as an output wired signal to the television monitor for playback, wherein the receiving component comprises a radio frequency receiver circuit and a receiving antenna,
wherein the output wired signal is identical to the input wired signal.

43. The remote cable system as claimed in claim 42, wherein the television further comprises at least one tuning means selected from the group consisting of airwave television channel tuners, cable television channel tuners, satellite television channel tuners, and combinations thereof.

44. The remote cable system as claimed in claim 43, wherein the transmitting component further comprises at least two input terminals for allowing input to the radio frequency transmitter circuit.

45. The remote cable system as claimed in claim 44, wherein the at least two input terminals allow input to the radio frequency transmitter circuit from at least two different input sources.

46. The remote cable system as claimed in claim 43, further comprising security means for allowing the receiving component to receive the wireless RF signal transmitted by the transmitting component.

47. The remote cable system as claimed in claim 46, wherein the security means comprises the use of electronic serial numbers.

48. The remote cable system as claimed in claim 46, wherein the security means comprises the use of electronic key cards.

49. The remote cable system as claimed in claim 43, wherein the input wired signal is a multi-channel cable television signal.
